(19) United States
(12) Patent Application Publication
(10) Pub. No.: US 2016/0186297 A1
(43) Pub. Date: Jun. 30, 2016

(54) ALUMINIUM ALLOY, MECHANICAL PARTS MADE THEREFROM, AND USE THEREOF

(71) Applicant: KONE Corporation, Helsinki (FI)

(72) Inventor: Simo MÄKIMATTILA, Shanghai (CN)

(73) Assignee: KONE Corporation, Helsinki (FI)

(21) Appl. No.: 14/963,745

(22) Filed: Dec. 9, 2015

(30) Foreign Application Priority Data
Dec. 29, 2014 (CN) 201410840662.X

(51) Int. Cl. C22C 21/08; B66B 23/12

(52) U.S. Cl. CPC C22C 21/08; B66B 23/12

(57) ABSTRACT

An aluminium alloy includes: 4 to 6% by weight of magnesium; 0.3 to 0.9% by weight of ferrum; 0.1 to 0.6% by weight of manganese; and 0.2 to 2% by weight of silicon. A mechanical part can be made from the aluminium alloy, and a method includes using the aluminium alloy in manufacturing a mechanical part.

### FIELD OF THE INVENTION

The present invention relates to aluminium alloys, and particularly to aluminium alloys for use in manufacturing high-strength, light-weight die-cast escalator step or auto-walk pallet.

### BACKGROUND OF THE INVENTION

Current escalator steps or auto-walk pallets are manufactured via two distinctively different manufacturing routes, namely
a) High-pressure die-casting of aluminium alloys to produce a one-piece casting of full step body,
b) Fabricated, mechanical assembly of separate components of cold-rolled stainless steels, low-carbon cold-rolled sheet assembled with cast-iron and other metallic and polymer parts welded or mechanically joined to form a step body.

Yield strength and tensile strength are two basic parameters widely used in engineering field. They are used for measuring the ability of metal materials to resist deformation and fracture under a loaded force. A die-cast aluminium alloy typically has yield strength up to 80-100 MPa but fractures at low total elongation of 1-2%. Due to the low strength and brittle fracture behavior of die-cast aluminium alloy, die-cast aluminium alloy steps are likely to break during service, and thus lead to risk of passenger injury.

Strength/weight ratio is another parameter to evaluate the performance of metal materials, which is the ratio between tensile strength and apparent density. A higher strength/weight ratio indicates that less mass of the material is required to reach a determined strength. So far the known attempts to improve strength/weight ratio of escalator step or auto-walk pallet castings are as follows:
Improve the strength of aluminium-silicon alloy. Aluminium-silicon alloys (8-13% Si) are the most extensively used alloys in die-casting. Thysse-Krupp has published studies to use rare-earth metals (as grain refiner during solidification) to produce an aluminium-silicon casting alloy material with improved properties. The resulting strength of silicon alloy material is lower than that of aluminium-magnesium alloys if used with current casting practice. The resulting ductility of silicon alloy material has not been observed to be improved.
Use high strength steel materials in combination with aluminium alloy materials, to achieve a safe and ductile behavior of the resulting escalator step or auto-walk pallet castings. This approach requires a long assembly process, and involves joining processes as well. Separate joining parts are costly in terms of, for instance, the associated labor and inspection, intermediate finishing and individual part fabrication.
Thyssen has published escalator steps made from fiber-reinforced plastics as a low-weight, less-noise solution. However material cost, production cost and fire-resistance may appear problems of implementation.
Automotive industry has developed aluminium-magnesium cast alloys for automotive body parts, shock absorber supports and wheel suspension parts because of energy-efficiency, fuel-efficiency and material saving.

### OBJECT AND SUMMARY OF THE INVENTION

The present invention is directed to an aluminium alloy, the mechanical parts made therefrom, and the use thereof. The aluminium alloy and the mechanical parts according to the present invention are suitable for use in a high-strength, light-weight die-cast escalator step or auto-walk pallet.

In one aspect of the invention, an aluminium alloy is provided. The aluminium alloy according to the present invention comprises:
4 to 6% by weight of magnesium;
0.3 to 0.9% by weight of ferrum;
0.1 to 0.6% by weight of manganese; and
0.2 to 2% by weight of silicon.

It has been observed that the aluminium alloy of the present invention has achieved higher strength, higher ductility and lower weight, as compared with existing aluminium alloys.

In another aspect of the invention, a mechanical part made from the aluminium alloy according to the present invention is provided. Specifically, the mechanical part is an escalator step, or an auto-walk pallet, for example.

It has been observed that the resulting escalator step or auto-walk pallet exhibited excellent performances including, but not limited to, lower weight, higher strength, and higher total elongation, as compared with the current escalator step or auto-walk pallet.

In still another aspect of the invention, use of the aluminium alloy according to the present invention is provided. By virtue of the enhanced performance, the aluminium alloy according to the present invention is suitable for use in manufacturing mechanical parts, especially for those are required to constantly or frequently withstand a high loaded force, such as mechanical parts of escalator steps or auto-walk pallets.

### DETAILED DESCRIPTION

Reference will now be made to embodiments of the disclosure, one or more examples of which are illustrated in the figures. The embodiments are provided by way of explanation of the disclosure, and are not meant as a limitation of the disclosure. For example, features illustrated or described as part of one embodiment may be used with another embodiment to yield still a further embodiment. It is intended that the disclosure encompass these and other modifications and variations as come within the scope and spirit of the disclosure.

According to one embodiment of the present invention, the aluminium alloy of the disclosure comprises 4 to 6% by weight of magnesium; 0.3 to 0.9% by weight of ferrum; 0.1 to 0.6% by weight of manganese; and 0.2 to 2% by weight of silicon.

One of ordinary skill in the art should understand that the aluminium alloy of the disclosure may comprise unavoidable impurities.

The aluminium alloy of the present invention has the required strength and higher fatigue strength to enable weight reduction.

The aluminium alloy of the present invention is suitable for use in manufacturing mechanical parts. Specifically, the aluminium alloy may be cast into the thin-walled escalator step or the auto-walk pallet. The resulting escalator step or auto-walk pallet has yield strength of 160 MPa and high ductility of 16% against step/pallet break. Furthermore, the escalator step or auto-walk pallet of the present invention meets the step/pallet ultimate breaking test load at lower step/pallet weight level, 15-20%, due to the lower material specific weight and the smaller cross-sectional area of the load carrying members.

The aluminium alloy of the present invention can be cast into a thin-wall thickness of 1.0-1.2 mm at minimum, by using tools according to the state-of-art, such as steel molds and dies, and by using currently known casting practices. The step cross section dimensions required by a normal cast step can be achieved with lower specific weight, higher strength and higher total elongation, which is more safe for escalator passenger in case of step breaking due to escalator misuse, unexceptional loading of step due to mechanical failure of other components, such as falling of foreign objects on step band, mechanical material fatigue, wear, aging and corrosion.

Escalators and auto-walks have several safety devices to prevent injury due to step crash. Step crash may occur due to mechanical failure of the guiding parts, chain, chain guide, step roller, drive chain or any dislocation, chain break, wear and misuse. In case of such crash the advantage of high-strength ductile material is that it does not break in brittle way but deforms preventing passenger fall.

Auto-walks operate in horizontal direction where the lower step weight contributes to lower power consumption because of reduction of moving masses vs passenger load and the associated lower friction force.

The die-cast escalator step or auto-walk pallet of the disclosure has the structural design and material properties as defined by the industry prior art as well as international codes and norms:
load forces determined by the step area where passengers can stand, 6000 N/m2, including additional strength due to safety factor of 3-4;
fatigue resistance up to 6 million load cycles;
corrosion resistance against road salt, marine climate;
friction coefficient against passenger footwear to prevent falling due to slippery, especially when escalator/auto-walk stops via safety devices activation;
corrosion resistance for outdoor use, in public transport facilities like metro stations, airports, against direct rainfall in marine climate;
corrosion resistance due to road salt in climatic zones of seasonal sub-zero temperatures for outdoor and indoor use;
thread design to allow smooth conduction of passenger over comb area;
wear resistance to keep the comb safety gap;
wear and dimensional stability (castability) to keep the skirting gap and comb gap safety function.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. An aluminium alloy comprising:
4 to 6% by weight of magnesium;
0.3 to 0.9% by weight of ferrum;
0.1 to 0.6% by weight of manganese; and
0.2 to 2% by weight of silicon.

2. A mechanical part made from the aluminium alloy according to claim 1.

3. The mechanical part according to claim 2, wherein the mechanical part includes at least one of:
an escalator step; and
an auto-walk pallet.

4. A method, comprising the step of using the aluminium alloy according to claim 1 in manufacturing a mechanical part.

5. The method according to claim 4, wherein the mechanical part includes at least one of:
an escalator step; and
an auto-walk pallet.
